(19) United States
(12) Patent Application Publication
(10) Pub. No.: US 2019/0016558 A1
(43) Pub. Date: Jan. 17, 2019

(54) INTERACTIVE PASSENGER MOVEMENT DEVICE FEATURES

(71) Applicant: OTIS Elevator Company, Farmington, CT (US)

(72) Inventors: Romain Durand, Amilly (FR); Loic Durudeau, Blancafort (FR)

(21) Appl. No.: 16/030,534

(22) Filed: Jul. 9, 2018

(30) Foreign Application Priority Data
Jul. 11, 2017 (EP) 17305902.3

(51) Int. Cl. B66B 3/00; B66B 27/00; B66B 31/02; B66B 11/02; B66B 1/34; B66B 23/24

(52) U.S. Cl. CPC B66B 3/008; B66B 3/002; B66B 27/00; B66B 23/24; B66B 11/0226; B66B 1/3461; B66B 31/02

(57) ABSTRACT

An elevator is provided and includes flooring, an elevator handrail, a display device incorporated within at least one of the flooring and the elevator handrail, a driving element which is configured to drive the elevator from a boarding location at which the passenger boards the elevator to a dismounting location at which the passenger dismounts from the elevator and a controller configured to control the display device to display information to the passenger while the passenger is aboard the elevator.

### CROSS-REFERENCE TO RELATED APPLICATIONS

This application claims the benefit of European Patent Application No. EP17305902.3, filed Jul. 11, 2017, which is incorporated herein by reference in its entirety.

### BACKGROUND

The following description relates to people conveyors and passenger movement devices and, more specifically, to interactive features of people conveyors and passenger movement devices.

A people conveyor or passenger movement device (hereinafter the phrase “passenger movement device” will be used to refer to people conveyors and passenger movement devices interchangeably) may be provided as an elevator, an escalator, a moving walkway, etc. In each case, the passenger movement device permits a passenger to board the passenger movement device, to ride the passenger movement device from a location where boarding occurred and to dismount the passenger movement device at a dismounting location. In the case of the passenger movement device being an elevator, the boarding and dismounting locations may be any floor of a building that the elevator services. In the case of the passenger movement device being an escalator or a moving walkway, the boarding and dismounting locations are predefined starting and ending points for the device.

In any case, conventional passenger movement devices do not convey substantial information to passengers except by way of certain, limited information delivery elements. For example, in the case of the passenger movement device being an elevator, the elevator may only include a panel that indicates what floors are serviced by the elevator and what floors have outstanding elevator calls in effect, a floor identification display that displays the floor the elevator is currently closest to, an output system that plays a predefined audio/visual recording and a certificate indicating the elevator certification. As such, the elevator includes several surfaces that are virtually unused for information display.

### BRIEF DESCRIPTION

According to an aspect of the disclosure, an elevator is provided and includes flooring, an elevator handrail, a display device incorporated within at least one of the flooring and the elevator handrail, a driving element which is configured to drive the elevator from a boarding location at which the passenger boards the elevator to a dismounting location at which the passenger dismounts from the elevator and a controller configured to control the display device to display information to the passenger while the passenger is aboard the elevator.

In accordance with additional or alternative embodiments, the flooring includes a screen including the display device, transparent flooring laid onto the screen and circuitry disposed underneath the screen for supporting the display of the information.

In accordance with additional or alternative embodiments, the elevator handrail includes a screen including the display device, transparent rail tubing laid onto the screen, supportive rail tubing disposed in support of the transparent rail tubing and circuitry extended through the supportive rail tubing and disposed underneath the screen for supporting the display of the information.

According to another aspect of the disclosure, an escalator or a walkway is provided and includes a looped handrail which moves with a passenger from a boarding location to a dismounting location, a display device incorporated within the looped handrail at a location corresponding to a location of the passenger, a driving element which is configured to drive the looped handrail from the boarding location to the dismounting location and a controller configured to control the display device to display information to the passenger while the passenger is aboard.

In accordance with additional or alternative embodiments, the looped handrail includes a screen including the display device, transparent handrail material laid onto the screen and wired or wireless circuitry disposed in signal communication with the screen for supporting the display of the information.

According to yet another aspect of the invention, a passenger movement device is provided and includes at least one of the above-described elevator and the above-described escalator or the walkway.

In accordance with additional or alternative embodiments, the display device includes a liquid crystal display (LCD).

In accordance with additional or alternative embodiments, the display device includes an organic light emitting diode (OLED) display.

In accordance with additional or alternative embodiments, the information displayable by the display device includes randomized information.

In accordance with additional or alternative embodiments, the information displayable by the display device includes current condition information.

In accordance with additional or alternative embodiments, the information displayable by the display device includes emergency information.

In accordance with additional or alternative embodiments, the information displayable by the display device includes personalized information.

In accordance with additional or alternative embodiments, the controller is communicative with a portable computing device.

In accordance with additional or alternative embodiments, the controller is communicative with a portable computing device of the passenger.

In accordance with additional or alternative embodiments, the information displayed to the passenger is derived from controller communication.

These and other advantages and features will become more apparent from the following description taken in conjunction with the drawings.

### BRIEF DESCRIPTION OF THE DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of an elevator with a display device incorporated in elevator flooring in accordance with embodiments;

FIG. 2 is a perspective view of an elevator with a display device incorporated in elevator flooring in accordance with embodiments;

FIG. 3 is a perspective view of an elevator with a display device incorporated in elevator flooring in accordance with embodiments;

FIG. 4 is a perspective view of an escalator with a display device incorporated in an escalator handrail in accordance with embodiments;

FIG. 5 is a perspective view of a moving walkway with a display device incorporated in a walkway handrail in accordance with embodiments;

FIG. 6 is a side view of elevator flooring with a display device incorporated therein in accordance with embodiments;

FIG. 7 is a perspective view of an elevator handrail with a display device incorporated therein in accordance with embodiments;

FIG. 8 is a cross-sectional view taken along lines 8-8 of FIG. 7;

FIG. 9 is a schematic axial view of an escalator or moving walkway handrail with a display device incorporated therein in accordance with embodiments; and

FIG. 10 is a schematic diagram of a controller in accordance with embodiments.

These and other advantages and features will become more apparent from the following description taken in conjunction with the drawings.

### DETAILED DESCRIPTION

As will be described below, passenger movement devices are provided that convey substantial information to passengers by way of various delivery devices. Such delivery devices may include, but are not limited to, flooring or handrails and may offer flexibility in terms of a type of information that can be conveyed. For example, in the case of flooring or handrails, the delivery devices may provide for audio and/or video play or streaming.

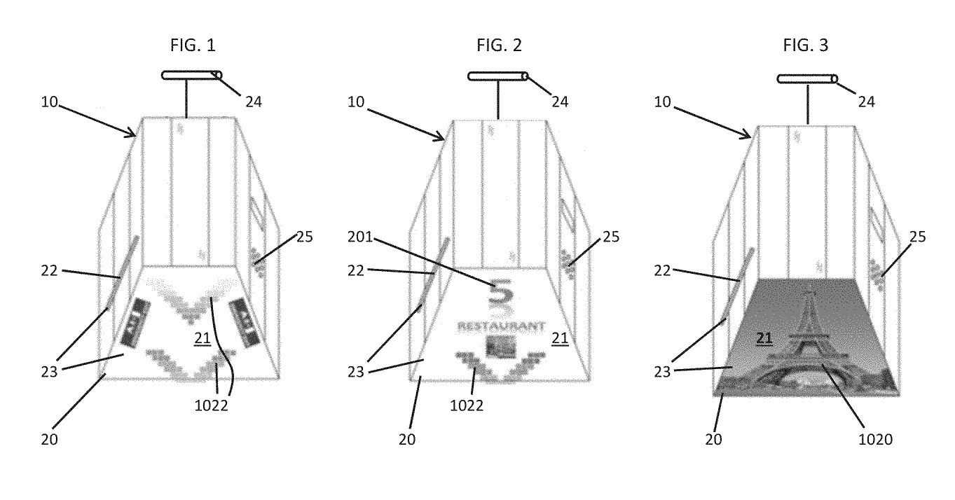

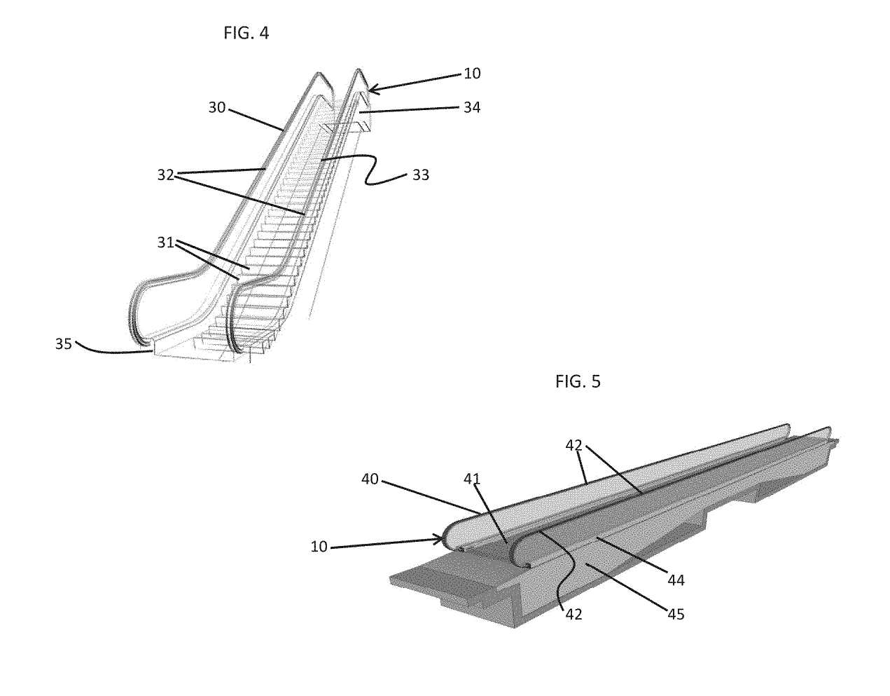

With reference to FIGS. 1-5, a passenger movement device 10 is provided as an elevator 20 (see FIGS. 1-3), an escalator 30 (see FIG. 4) or as a moving walkway 40 (see FIG. 5).

In the case of the passenger movement device 10 being an elevator 20, as shown in FIGS. 1-3, the passenger movement device 10 includes elevator flooring 21 as a surface on which a passenger is supportable, an elevator handrail 22 as a railing which is grippable by the passenger for additional support, a display device 23 that may be provided as at least one of a liquid crystal display (LCD) and an organic light emitting diode (OLED) display and which is incorporated within at least one of the elevator floor 21 and the elevator handrail 22, a driving element 24 and a controller 25.

In the case of the elevator 20, the driving element 24 may be provided as a hoistway machine and is, in any case, configured to drive the elevator 20 (and the elevator flooring 21 and the elevator handrail 22) from a boarding location, level or floor at which the passenger boards the elevator 20 to a dismounting location, level or floor at which the passenger dismounts from the elevator 20. The controller 25 may be provided as a computing device that is coupled to the elevator 20 and to the display device 23 in particular and configured to control the display device 23 to display information to the passenger while the passenger is aboard the elevator 20.

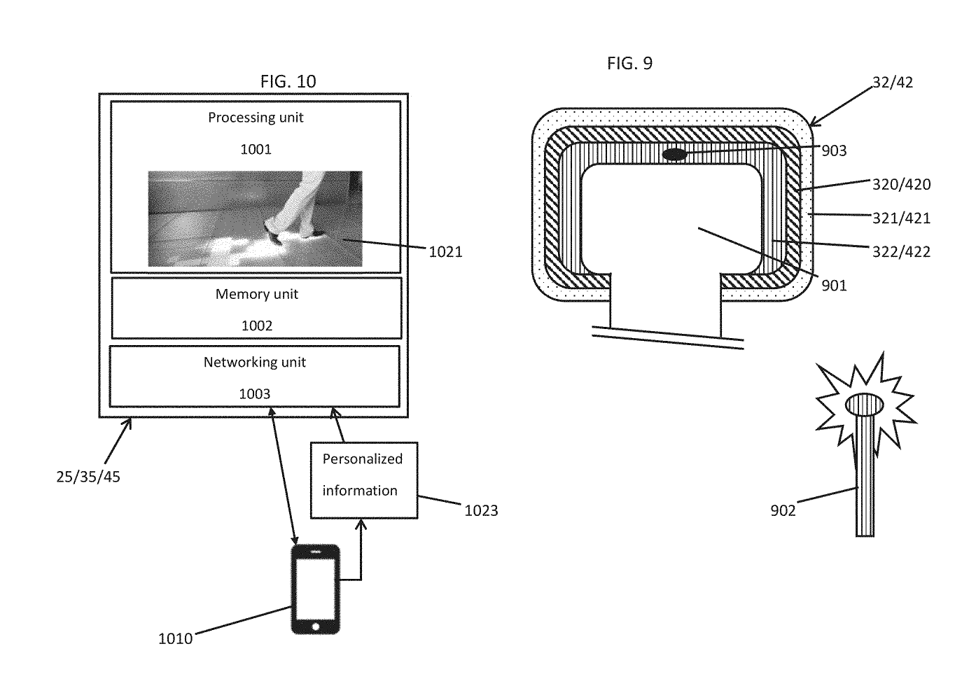

In the case of the passenger movement device 10 being an escalator 30, as shown in FIG. 4, the passenger movement device 10 includes an escalator step 31 as a surface on which a passenger is supportable, an escalator handrail 32 as a railing which is grippable by the passenger for additional support, a display device 33 (see FIG. 9) that may be provided as at least one of a liquid crystal display (LCD) and an organic light emitting diode (OLED) display and which is incorporated within at least one of the escalator step 31 and the escalator handrail 32, a driving element 34 and a controller 35.

In the case of the escalator 30, the driving element 34 may be provided as a motor and is, in any case, configured to drive movable components of the escalator 30, that is the discrete escalator steps 31 and correspondingly discrete sections of the escalator handrail 32, from a boarding location, level or floor at which the passenger boards the escalator 30 to a dismounting location, level or floor at which the passenger dismounts from the escalator 30. The controller 25 may be provided as a computing device that is coupled to the escalator 30 and to the display device 33 in particular and configured to control the display device 33 to display information to the passenger at or proximate to the discrete escalator steps 31 and the corresponding discrete sections of the escalator handrail 32 while the passenger is aboard the escalator 30.

In the case of the passenger movement device 10 being a moving walkway 40, as shown in FIG. 5, the passenger movement device 10 includes a walkway surface 41 as a surface on which a passenger is supportable, a walkway handrail 42 as a railing which is grippable by the passenger for additional support, a display device 43 that may be provided as at least one of a liquid crystal display (LCD) and an organic light emitting diode (OLED) display and which is incorporated within at least one of the walkway surface 41 and the walkway handrail 42, a driving element 44 and a controller 45.

In the case of the moving walkway 40, the driving element 44 may be provided as a motor and is, in any case, configured to drive the movable components of the moving walkway 40, that is discrete sections of the walkway surface 41 and correspondingly discrete sections of the walkway handrail 42, from a boarding location at which the passenger boards the moving walkway 40 to a dismounting location at which the passenger dismounts from the moving walkway 40. The controller 45 may be provided as a computing device that is coupled to the moving walkway 40 and to the display device 43 in particular and configured to control the display device 43 to display information to the passenger at or proximate to the discrete sections of the walkway surface 41 and the corresponding discrete sections of the walkway handrail 42 while the passenger is aboard the moving walkway 40.

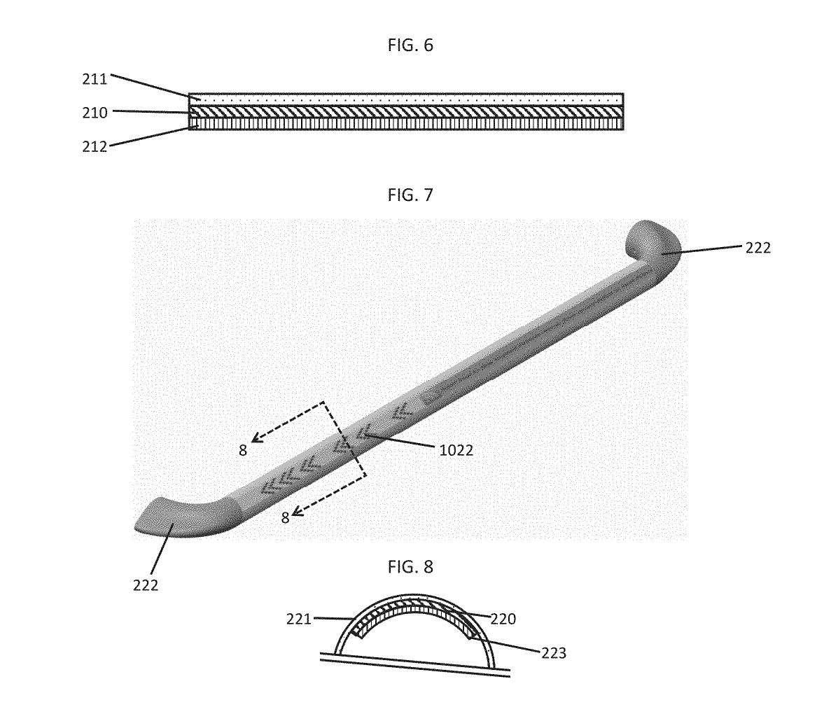

With reference back to FIGS. 1-3 and with additional reference to FIG. 6, in a case in which the display device 23 is incorporated within the elevator flooring 21, the elevator flooring 21 may include a screen 210, which includes the display device 23 itself, a transparent flooring layer 211 that is laid onto an upper surface of the screen 210 and a circuitry layer 212. The transparent flooring layer 211 may be made of transparent material, such as fiberglass or another suitable material, which serves to protect the screen 210 while allowing images displayed on the screen 210 to be visible to a passenger. The circuitry layer 212 is disposed underneath the screen 210 for supporting the display of the information.

With reference back to FIGS. 1-3 and with additional reference to FIGS. 7 and 8, in a case in which the display device 23 is incorporated within the elevator handrail 22, the elevator handrail 22 may include a screen 220, which includes the display device 23 itself, transparent rail tubing 221 that is laid onto the screen 220, supportive rail tubing 222 that is disposed in support of the transparent rail tubing 221 and circuitry 223. The transparent rail tubing 221 may be made of transparent material, such as fiberglass or another suitable material, which serves to protect the screen 220 while allowing images displayed on the screen 220 to be visible to a passenger. The supportive rail tubing 222 may be provided at distal ends of the screen 220 and the transparent rail tubing 221 as support on a sidewall of the elevator 20. The circuitry 223 is extended through the supportive rail tubing 222 and is disposed underneath the screen 220 for supporting the display of the information.

With reference back to FIGS. 4 and 5 and with additional reference to FIG. 9, in a case in which the display device 33 is incorporated within the escalator handrail 32 and in a case in which the display device 43 is incorporated within the walkway handrail 42, the escalator handrail 32 and the walkway handrail 42 may both be provided as a looped handrail 32 and 42 which moves with a passenger from a boarding location to a dismounting location with the display device 33 and 43 thus being incorporated as a moving feature within the looped handrail 32 and 42 at a location corresponding to the location of the passenger. Here, the driving element 34 of the escalator 30 and the driving element 44 of the moving walkway 40 are configured to drive the looped handrail 32 and 42 from the boarding location to the dismounting location, around a return curve and back again in a continuing loop.

As shown in FIG. 9, the looped handrail 32 and 42 may include a screen 320 and 420, which includes the display device 33 and 43 itself, transparent looped handrail material 321 and 421 that is laid onto the screen 320 and 420, some combination of wired and/or wireless circuitry 322 and 422 which is disposed in signal communication with the screen 320 and 420 for supporting the display of the information and a looped guide bar 901 on which the looped handrail 32 and 42 is borne and supported. The transparent looped handrail material 321 and 421 may be made of transparent material, such as fiberglass or another suitable material, which serves to protect the screen 220 while allowing images displayed on the screen 220 to be visible to a passenger and while being flexible enough to maintain functionality and position in the return curves. The wired and/or wireless circuitry 322 and 422 may be provided with an antenna 902 that is remote from the guide bar 901 and a receiver 903 that is provided on the guide bar 901 whereby signals can be provided to the display device 33 and 43 while the display device 33 and 43 is moving.

With reference to FIG. 10, the controller 25 of the elevator 20, the controller 35 of the escalator 30 and the controller 45 of the moving walkway 40 may be provided as a computing device. As shown in FIG. 10, the controller 25, 35 and 45 may each include a processing unit 1001, a memory unit 1002 and a networking unit 1003 by which the processing unit 1001 is communicative with the display device 23, 33 and 43 or with a portable computing device 1010 of a passenger, such as a smartphone, a tablet or a laptop. The memory unit 1002 has executable instructions stored thereon, which, when executed cause the processing unit 1001 to determine that a passenger is aboard, to communicate with the display device 23, 33 and 43 or with the portable computing device 1010 and to thus execute a measure of control of the display device 23, 33 and 43 to display certain information of which at least some may be derived from communications between the controller 25 and the portable computing device 1010.

The information displayable by the display device 23, 33 and 43 may include randomized information 1020, such as a picture chosen from random (see FIG. 3) or step illumination 1021 (see FIG. 10), current condition information 201, such as a displayed floor number (see FIG. 2), emergency information 1022, such as an arrow indicating a direction a passenger needs to walk in during an emergency (see FIGS. 1, 2 and 7) and personalized information 1023, such as a picture taken from the passenger's portable computing device 1010 or broadcasted data that is relevant to a video the passenger was previously watching on the portable computing device 1010 (see FIG. 10).

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. An elevator, comprising:
flooring;
an elevator handrail;
a display device incorporated within at least one of the flooring and the elevator handrail;
a driving element which is configured to drive the elevator from a boarding location at which the passenger boards the elevator to a dismounting location at which the passenger dismounts from the elevator; and
a controller configured to control the display device to display information to the passenger while the passenger is aboard the elevator.

2. The elevator according to claim 1, wherein the flooring comprises:
a screen including the display device;
transparent flooring laid onto the screen; and
circuitry disposed underneath the screen for supporting the display of the information.

3. The elevator according to claim 1, wherein the elevator handrail comprises:
a screen including the display device;
transparent rail tubing laid onto the screen;
supportive rail tubing disposed in support of the transparent rail tubing; and
circuitry extended through the supportive rail tubing and disposed underneath the screen for supporting the display of the information.

4. An escalator or a walkway, comprising:
a looped handrail which moves with a passenger from a boarding location to a dismounting location;
a display device incorporated within the looped handrail at a location corresponding to a location of the passenger;
a driving element which is configured to drive the looped handrail from the boarding location to the dismounting location; and
a controller configured to control the display device to display information to the passenger while the passenger is aboard.

5. The escalator or the walkway according to claim 4, wherein the looped handrail comprises:
a screen including the display device;
transparent handrail material laid onto the screen; and
wired or wireless circuitry disposed in signal communication with the screen for supporting the display of the information.

6. A passenger movement device comprising at least one of:
an elevator, comprising flooring, an elevator handrail, a display device incorporated within at least one of the flooring and the elevator handrail, a driving element which is configured to drive the elevator from a boarding location at which the passenger boards the elevator to a dismounting location at which the passenger dismounts from the elevator and a controller configured to control the display device to display information to the passenger while the passenger is aboard the elevator; and
an escalator or a walkway, comprising a looped handrail which moves with a passenger from a boarding location to a dismounting location, a display device incorporated within the looped handrail at a location corresponding to a location of the passenger, a driving element which is configured to drive the looped handrail from the boarding location to the dismounting location and a controller configured to control the display device to display information to the passenger while the passenger is aboard.

7. The passenger movement device according to claim 6, wherein the display device of the elevator or the display device of the escalator or the walkway comprises a liquid crystal display (LCD).

8. The passenger movement device according to claim 6, wherein the display device of the elevator or the display device of the escalator or the walkway comprises an organic light emitting diode (OLED) display.

9. The passenger movement device according to claim 6, wherein the information displayable by the display device of the elevator or by the display device of the escalator or the walkway comprises randomized information.

10. The passenger movement device according to claim 6, wherein the information displayable by the display device of the elevator or by the display device of the escalator or the walkway comprises current condition information.

11. The passenger movement device according to claim 6, wherein the information displayable by the display device of the elevator or by the display device of the escalator or the walkway comprises emergency information.

12. The passenger movement device according to claim 6, wherein the information displayable by the display device of the elevator or by the display device of the escalator or the walkway comprises personalized information.

13. The passenger movement device according to claim 6, wherein the controller of the elevator or the controller of the escalator or the walkway is communicative with a portable computing device.

14. The passenger movement device according to claim 6, wherein the controller of the elevator or the controller of the escalator or the walkway is communicative with a portable computing device of the passenger.

15. The passenger movement device according to claim 13, wherein the information displayed to the passenger is derived from controller communication.
